(19) United States
(12) Patent Application Publication
(10) Pub. No.: US 2003/0007253 A1
(43) Pub. Date: Jan. 9, 2003

(54) Large-apertured projection lens with minimal diaphragm error

(76) Inventors: Karl-Heinz Schuster, Konigsbronn (DE); Wilhelm Ulrich, Aalen (DE)

Correspondence Address: M. Robert Kestenbaum, 11011 Bermuda Dunes NE, Albuquerque, NM, 87111, US

(21) Appl. No.: 09/917,504

(22) Filed: Jul. 27, 2001

Related U.S. Application Data
(63) Continuation-in-part of application No. PCT/EP99/09235, filed on Nov. 27, 1999.

(30) Foreign Application Priority Data
Nov. 30, 1998 (DE) 198 55 108.8
Nov. 30, 1998 (DE) 198 55 157.6
May 14, 1999 (DE) 199 22 209.6
Apr. 9, 1999 (DE) 199 42 281.8

(51) Int. Cl. G03B 27/42; G02B 3/00; G02B 7/00; G02B 13/00; G02B 13/04

(52) U.S. Cl. 359/642; 359/749

(57) ABSTRACT

The invention relates to a large-apertured microlithography projection lens. The diaphragm error is also systematically corrected, so that the pupil plane is slightly curved and the lens can be stopped down without comprising quality. The system diaphragm of the projection lens is located in the area of the last lens cluster of positive refractive power on the image side. The telecentrics of the projection lens remain stable on the image side during stopping down.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The invention relates to a microlithographic projection lens, in which the system diaphragm is arranged in the region of the last bulge on the image side, and has a numerical aperture of more than 0.65 and an image field diameter of more than 20 mm. Such lenses are typically characterized by a resolution below 0.5 micrometers with minimal distortion and at least image-side telecentricity.

The microlithographic reduction lens of the category concerned is a microlithographic projection lens having a system diaphragm arranged in a region of a last bulge on an image side, and having an image-side numerical aperture of more than 0.65 and an image field diameter of more than 20 mm, and is a purely refractive high performance lens such as is required for high resolution microlithography, particularly in the DUV wavelength region.

### TECHNICAL FIELD

Such refractive lenses with two beam waists have already been described in the article by E. Glatzel, “New Lenses for Microlithography”, SPIE, Vol. 237, 310 (1980), and have been constantly developed since then. Lenses of the Carl Zeiss company of the category concerned are sold in PAS wafer steppers and wafer scanners of the ASML company, Netherlands.

Such a lens by the Tropel company dating from 1991 is shown in FIG. 16 of J. H. Bruning, “Optical Lithography—Thirty Years and Three Orders of Magnitude”, SPIE, Vol. 3049, 14-27 (1997). Numerous variants of projection lenses of the category concerned can be found in patent applications, such as EP 0 712 019-A (U.S. Ser. No. 337,649 of Nov. 10, 1994), EP 0 717 299-A, EP 0 721 150-A, EP 0 732 605-A, EP 0 770 895-A, EP 0 803 755-A (U.S. Pat. No. 5,781,278), and EP 0 828 172-A.

Similar objectives with somewhat smaller numerical aperture are also to be found in SU 1 659 955-A, EP 0 742 492-A (FIG. 3), U.S. Pat. No. 5,105,075 (FIGS. 2 and 4), U.S. Pat. No. 5,260,832 (FIG. 9) and DD 299 017-A.

In the cited documents, the diaphragm of course has many different situations, in particular in the region of the second waist.

The possibility of stopping down to about 60-80% of the maximum image-side numerical aperture is as a rule provided in high-aperture microlithography projection lenses.

This possibility of stopping down is explicitly mentioned in DE 199 02 236 A1, which was first published after the priority date of the present application. In this, and also in DE 198 18 444 A1, the use of aspheric lenses is also provided, and indeed at least one aspheric in the region of the second waist (fourth lens group). The embodiments of FIGS. 1-3 of the priority application DE 198 55 108.8 show a relatively strongly curved pupil plane with an axial offset of about 25 mm between the optical axis and the edge of the pencil of rays at full aperture. Correspondingly, expensive diaphragm structures are required for stopping down.

The priority applications DE 198 55 108.8, DE 198 55 157.6 and DE 199 22 209.6, DE 199 42 281.8, with their disclosures and including the claims, are incorporated herein by reference as part of the disclosure of the present patent application.

As “pupil plane” there is understood, in the sense of the present patent application, the curved surface of the pupil or, fourier transformed, of the image plane, as it is constituted real due to imaging errors of the lens arrangement. The edge of the aperture diaphragm of the system must lie on this surface if vignetting effects are to be prevented. If the real aperture diaphragm is made narrower and wider in a planar geometrical plane, the freedom from vignetting is approximately the better, the less the pupil plane departs from a planar surface.

### SUMMARY OF THE INVENTION

The invention has as its object the provision of lenses of the category concerned with well corrected pupils, making possible cleaner stopping down without disturbing effects and with a simple diaphragm structure.

This object is attained by a projection lens of the category concerned wherein a pupil plane is curved over a cross section of a pencil of rays by a maximum of 20 mm.

This object is also attained by a projection lens of the category concerned wherein the lens has a telecentricity deviation of less than ±4 mrad, preferably less than ±3 mrad of the geometric central beam, on stopping down to 0.8 times the image side numerical aperture. This object is also attained by a projection lens of the category concerned wherein a tangential image dishing of a pupil image in a diaphragm space is corrected to less than 20 mm, preferably less than 15 mm.

According to the invention, the pupil plane is curved by at most 20 mm, but preferably by less than 15 mm.

The image-side telecentricity is also well kept very stable, even when stopping down to 0.8 times the nominal (maximum) image-side numerical aperture; measured at the geometrical central beam, it is below ±4 mrad.

Since the image field curvature of the front or rear lens portion cannot be exactly corrected alone (or at all events not at a justifiable expense, since it can only be influenced by means of the distribution of refractive index), the image error compromise in the image plane is chosen so that the image field curvature is partially compensated by astigmatism (which can be adjusted by means of targeted lens curvature with unchanged refractive index), at least in the tangential imaging relevant for the diaphragm structure.

According to the invention, apart from the optical correction of the lens, the tangential image dishing of the pupil imaging in the diaphragm space is corrected to less than 20 mm. Imaging of the pupil plane is thus explicitly taken into account in the image error compromise of the lens.

A negative lens is required in the space behind the pupil plane for the correction of spherical aberration in projection lenses of the category concerned.

According to the invention, the pupil correction according to the invention is now attained with the presence of a pupil-side concave meniscus, and makes possible a good correction of all imaging errors. The flatter the diverging image-side radius of the negative lens, the more favorable this lens is for the pupil correction.

A diaphragm position according to the invention is clearly away from the second waist, and is also different from DE 199 02 336 A1 and from other documents of the prior art.

The beam deflection in this region of the third bulge with many weak positive lenses results in minimum spherical under-correction and thus makes possible weak negative lenses, which further relaxes the correction of the pupil plane. The variation of the image errors when stopping down or at different illumination settings is further reduced as a whole by these measures.

The spherically over-correcting air space advantageously provided according to the invention and having a middle thickness greater than the edge thickness can be arranged in the neighborhood of the negative meniscus.

An aspheric lens is arranged in the region of the first waist. Aspherics in the region of the second waist can be dispensed with, while in the state of the art according to DE 199 02 336 A1 and DE 198 18 444 A1 they are to be arranged exactly there.

According to the invention, the material of the lenses is quartz glass and/or fluoride crystals, the lenses then becoming suitable for the DUV/VUV region, in particular at the wavelengths of 248 nm, 193 nm, and 157 nm. Fluoride crystals are CaF₂, BaF₂, SrF₂, NaF and LiF. Further information on this may be found in DE 199 08 544.

The projection lens according to the invention has two waists and three bulges, as in the embodiment examples. This makes possible a very good Petzval correction at exacting values of the aperture and field.

A projection illumination device with a lens according to the invention and a microlithographic production process therewith.

The possibility, optimized according to the invention, provides for the application of exposures with different kinds of illumination and/or numerical aperture.

### BRIEF DESCRIPTION OF THE DRAWINGS

The invention is described in more detail with the aid of the embodiment examples according to the drawing and the tables.

FIG. 1 shows qualitatively a projection exposure device according to the invention.

FIG. 2 shows the lens section of a 103 nm quartz glass/CaF₂ projection lens with NA=0.70.

FIG. 3 shows the lens section through a second lens arrangement, which has two aspheric lens surfaces;

FIG. 4 shows the lens section through a third lens arrangement, which has three aspheric surfaces;

FIGS. 5a-5g show a representation of tangential transverse aberrations;

FIGS. 6a-6g show a representation of sagittal transverse aberrations;

FIGS. 7a-7f show a representation of groove error, using sections;

FIG. 8 shows the lens section through a fourth lens arrangement for 248 nm with NA=0.70.

### DETAILED DESCRIPTION OF THE INVENTION

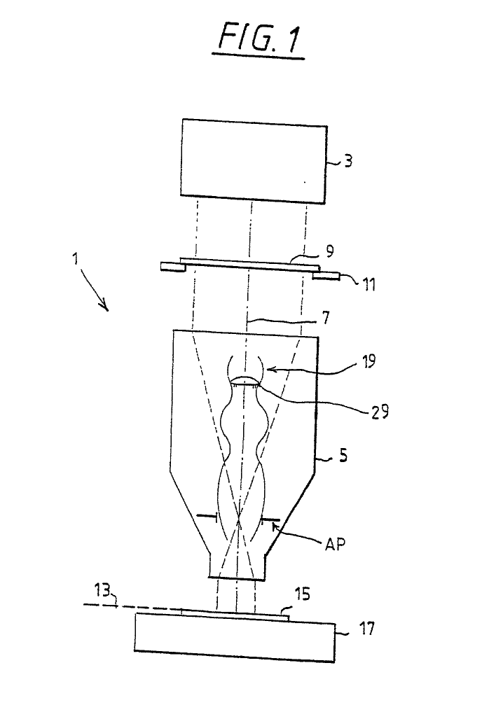

The principle of the construction of a projection exposure device will first be described using FIG. 1. The projection exposure device 1 has an illuminating device 3 and a projection lens 5. The projection lens includes a lens arrangement 19 with an aperture diaphragm AP, an optical axis 7 being defined through the lens arrangement 19. A mask 9 is arranged between the illuminating device 3 and the projection lens 5, and is held in the beam path by a mask holder 11. Such masks 9 used in microlithography have a microstructure which is imaged on a reduced scale on an image plane 13 by means of the projection lens 5. A substrate or a wafer 15, positioned by a substrate holder 17, is held in the image plane 13.

This projection lens 5, and in particular its lens arrangement 19, designed for more stringent requirements on image quality and on resolution, is described in more detail hereinafter.

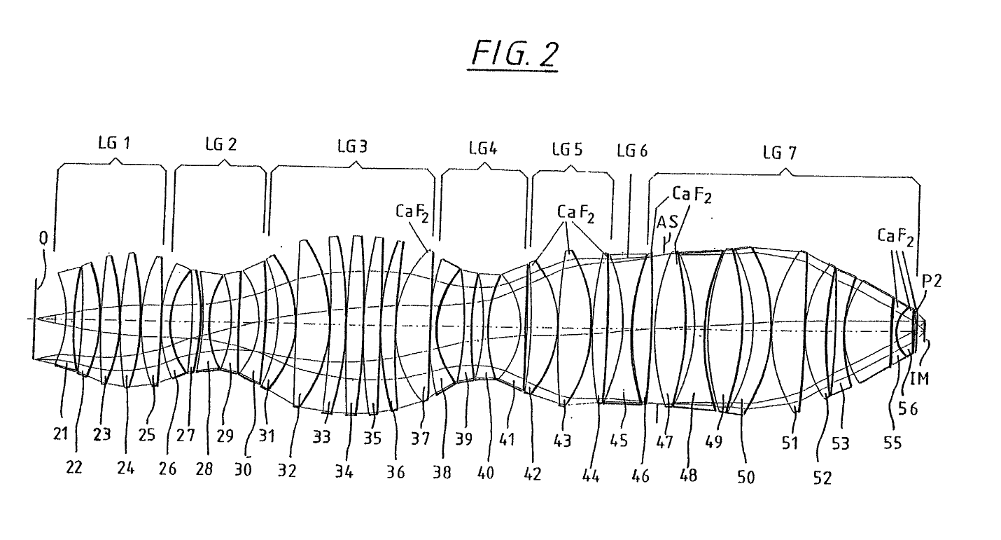

The embodiment example according to FIG. 2 and Table 1 is a projection lens with purely spherical lenses, as a quartz glass/CaF₂ partial achromat for 193 nm excimer laser with 0.5 pm bandwidth. The image-side NA is 0.70; the image field diameter is 29.1 mm. The pupil plane with the aperture stop AS is situated far back from the second waist in the region of an intermediate constriction of the third bulge. Its curvature is 15.8 mm at a light pencil diameter of 212 mm.

For the determination of the curvature of the pupil plane, the tangential image shell of the pupil image in the diaphragm space is determined such that the axial amount of image deviation, produced between the image plane and the pupil plane by the lens portion, of a parallel beam passing at the aperture angle through the image field is determined as compared with the image of a parallel beam parallel to the axis. The not large sagittal value for stopping down and vignetting is 26.5 mm here, and thus shows the introduced astigmatism.

With stopping down to NA=0.56, the lens shows a deviation from telecentricity of the geometric central beam of 3 mrad.

It would be particularly valuable to design this lens arrangement for a small diameter of the CaF₂ lenses, since their availability is restricted.

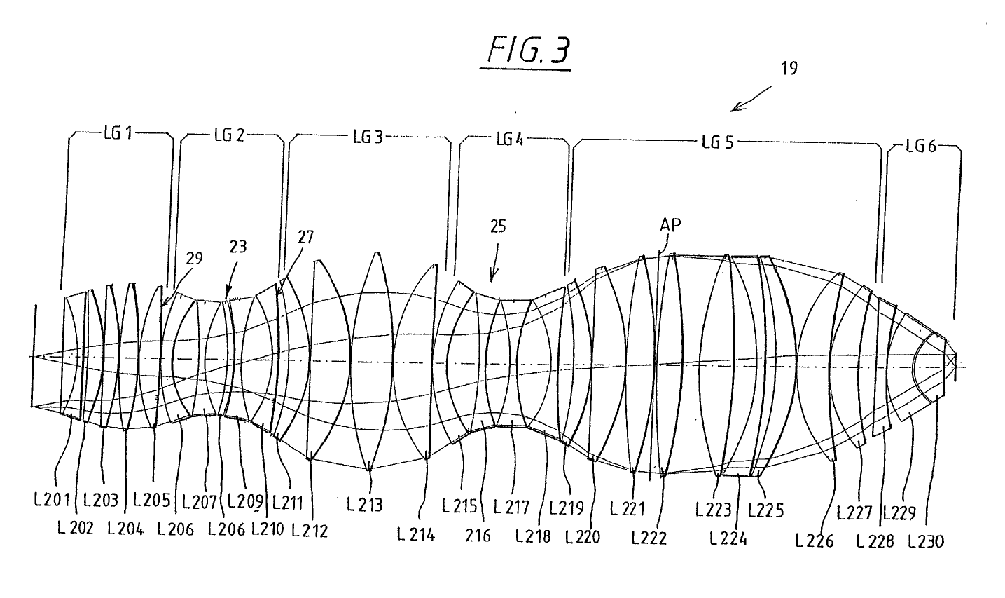

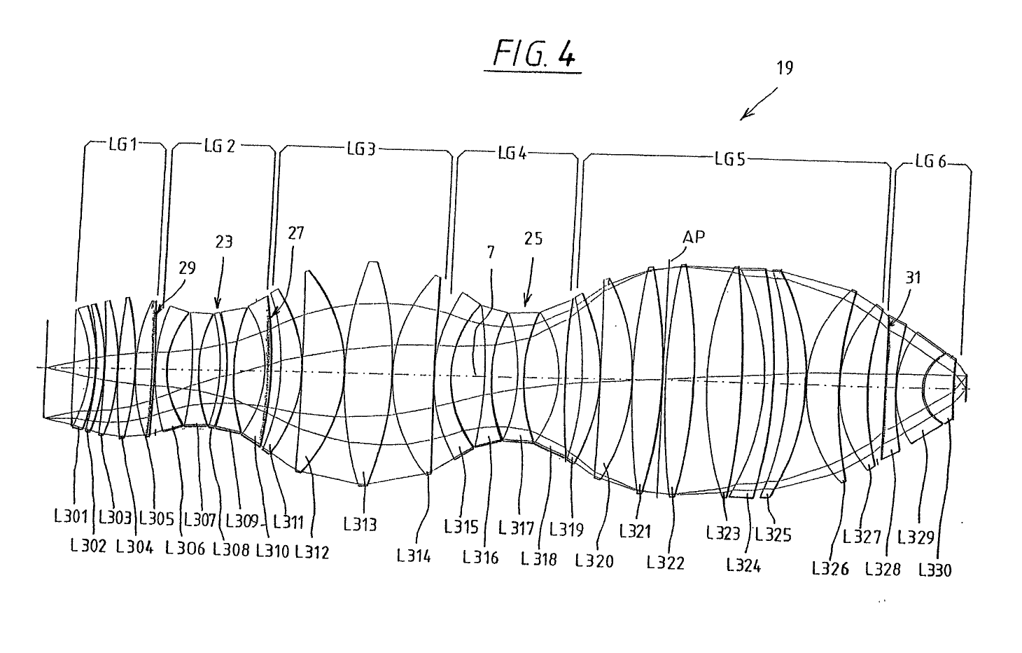

The examples of FIGS. 3 and 4 have aspherics. These aspheric surfaces are described by the equation

$$P ( h ) = \frac{δ * {h}^{2}}{1 + √ 1 - ( 1 - EX ) * {δ}^{2} * {h}^{2}} + {C1h}^{4} + … + {C}_{n} {h}^{2 n - 2} with δ = 1 / R$$

where P is the arrow height as a function of the radius h (height from the optical axis 7) with the aspheric constants C₁-Cₙ given in the Tables. R is the vertex radius given in the Tables.

In FIG. 3 and Table 2, a quartz glass lens arrangement 19 designed for the wavelength λ=248 nm is shown in section. This lens arrangement 19 with NA=0.75 and image field diameter 27.2 mm has two aspheric lens surfaces 27, 29. The first aspheric lens surface 27 is arranged on the image side on the lens L210. It could also be provided that this second aspheric lens surface 29 is arranged on the side of the lens L211 facing toward the illuminating device. The two lenses L210 and L211 are predetermined to receive the aspheric lens surface 27. It can also be provided that a meniscus lens is provided instead of the lenses L210 and L211, and has an aspheric lens surface. The second aspheric lens surface 29 is arranged in the end region of the first lens group, on the side of the lens L205 remote from the illuminating device 8. It can also be provided that this aspheric lens surface 29 is arranged on the lens 206 following thereafter, in the beginning of the second lens group.

A particularly large effect is obtained on arranging the aspherics 27, 29 on lens surfaces at which the incident rays include a large angle with the respective surface normals. In this case, it is particularly the large variation of the angle of incidence which is of importance. In FIG. 10, the value of sin i at the aspheric lens surface 31 reaches a value of up to 0.82. As a result of this, the mutually facing surfaces of the lenses L210, L211 have in this embodiment example a greater influence on the course of the rays in comparison to the respective other lens surface of the corresponding lens L210, L211.

No aspheric is provided in the region of the second waist, lens group LG4.

With a length of 1,000 mm and a maximum lens diameter of 237.5 mm, this lens arrangement has a numerical aperture of 0.75 at a wavelength of 248.38 mn. The image field diagonal is 27.21 mm. A structure width of 0.15 μm can be resolved. The greatest deviation from the ideal wavefront is 13.0 mλ. The exact lens data with which these performance data are attained are given in Table 2.

The pupil plane intersects the optical axis at AP. Its curvature is 12.8 mm. A stopping down to NA=0.60 is possible without loss of quality with a diaphragm situated in the plane AP. The deviation from telecentricity of the geometric central beam is then about 1.5 mrad.

A further embodiment of a lens arrangement 19 for the wavelength 248.38 nm is shown in FIG. 4 and Table 3. With an image-side NA=0.77, the image field diameter is 27.2 mm.

This lens arrangement 19 has three lenses L305, L310, L328, which have respective aspheric surfaces 27, 29, 31. The aspheric lens surfaces 27, 29 are left in the positions given by FIG. 3. The coma of middle order for the image field zone can be adjusted by means of the aspheric lens surface 27. The repercussions on sections in the tangential direction and sagittal direction are small.

The additional aspheric lens surface 31 is arranged on the mask side on the lens L328. This aspheric lens surface 31 supports the coma correction to the image field edge.

By means of these three aspheric lens surfaces 27, 29, 31, at a wavelength of 248.34 nm, a length of only 1,000 mm, and a maximum lens diameter of 247.2 mm, there are attained the further increased numerical aperture of 0.77 and a structure width of 0.14 μm which can be well resolved in the whole image field. The maximum deviation from the ideal wavefront is 12.0 mλ.

In order to keep the diameter of the lenses in LG5 small, and in order for an advantageous Petzval sum, which is to be kept at nearly zero, for the system, the three lenses L312, L313, L314 are enlarged in the third lens group LG3. For the provision of the required axial constructional space for these three lenses L312-L314, the thicknesses, and hence the diameter, of other lenses are reduced, particularly of the lenses of the first group LG1. This is an excellent way to accommodate very large image fields and apertures in a restricted constructional space.

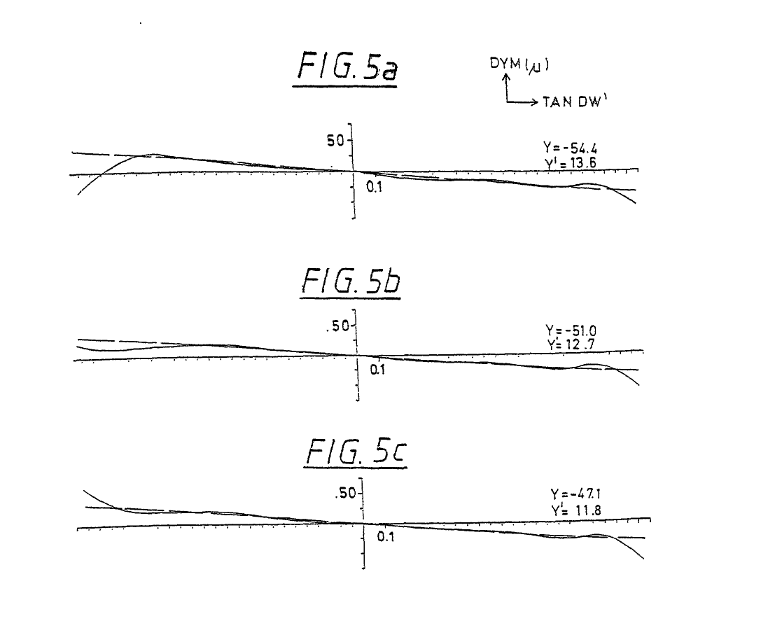

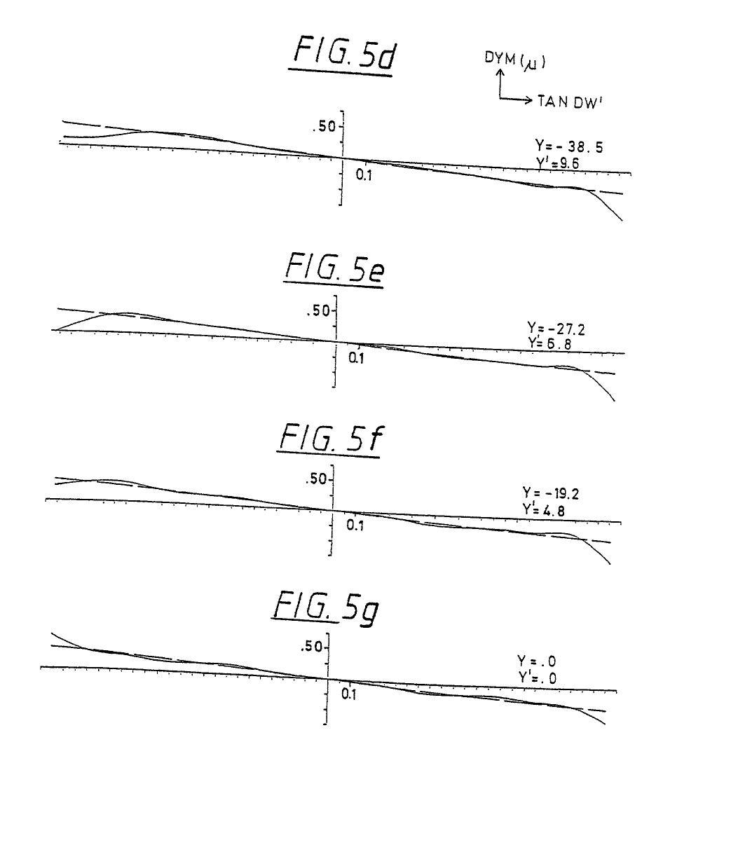

The high image quality attained by this lens arrangement is to be gathered from FIGS. 5a-5g, FIGS. 6a-6g, and FIGS. 7a-7f.

FIGS. 5a-5g give the meridional transverse aberrations DYM for the image heights Y′ (in mm). All show an outstanding course up to the highest DW′.

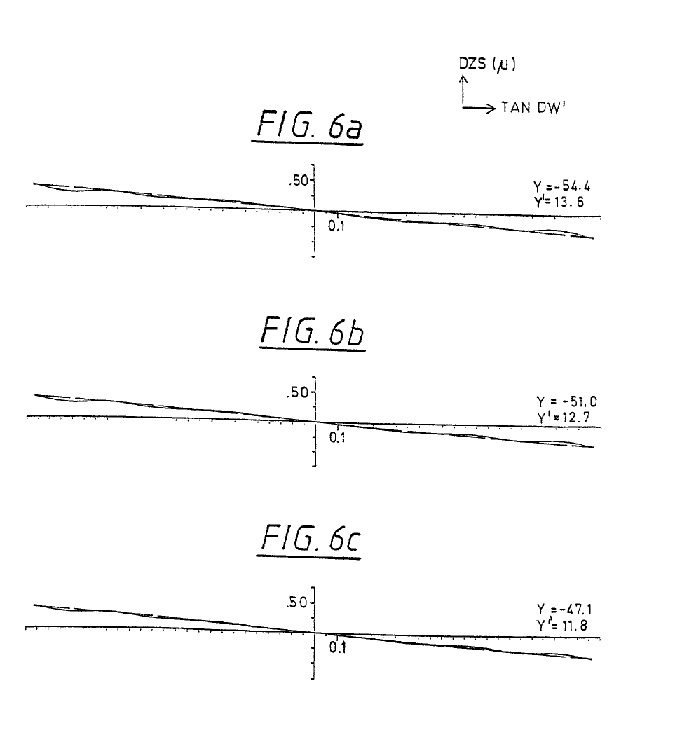

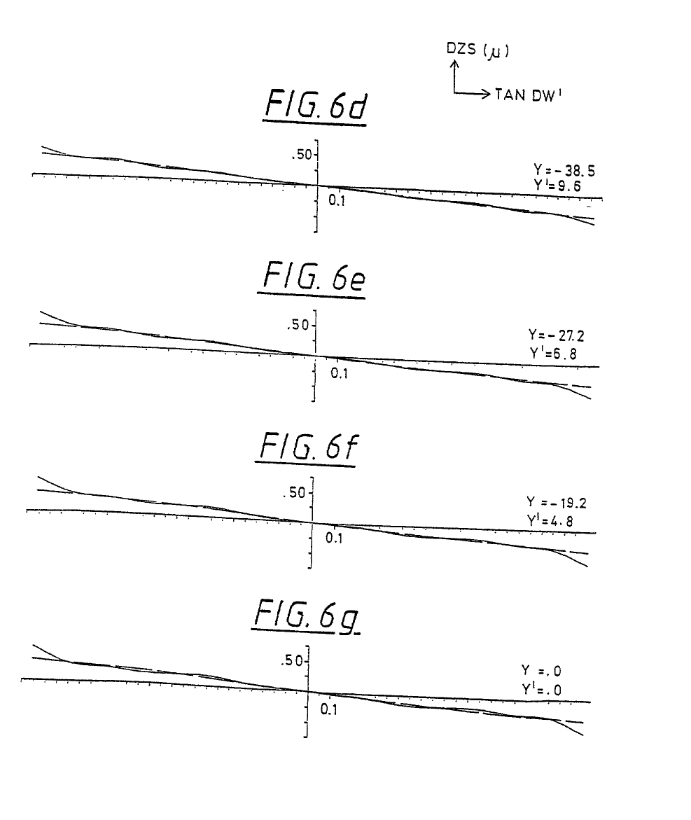

FIGS. 6a-6g give the sagittal transverse aberrations DZS as a function of the half aperture angle DW′.

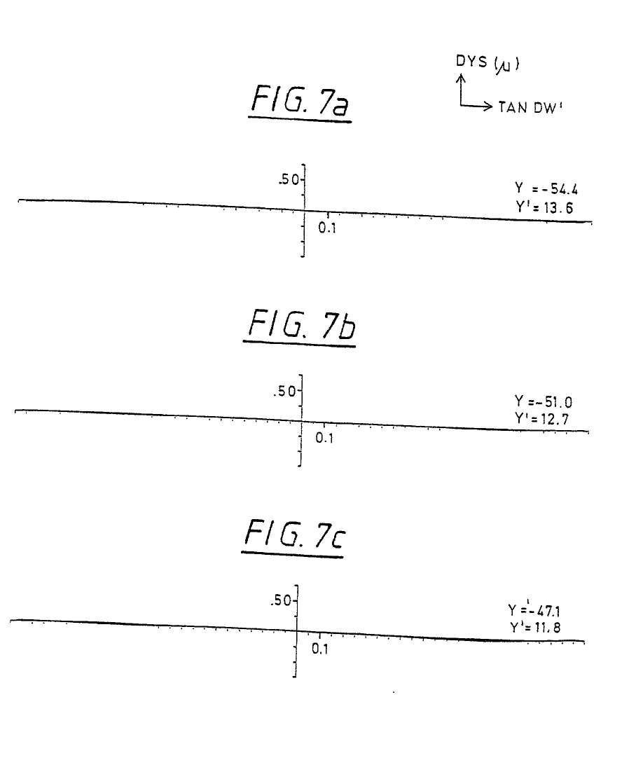

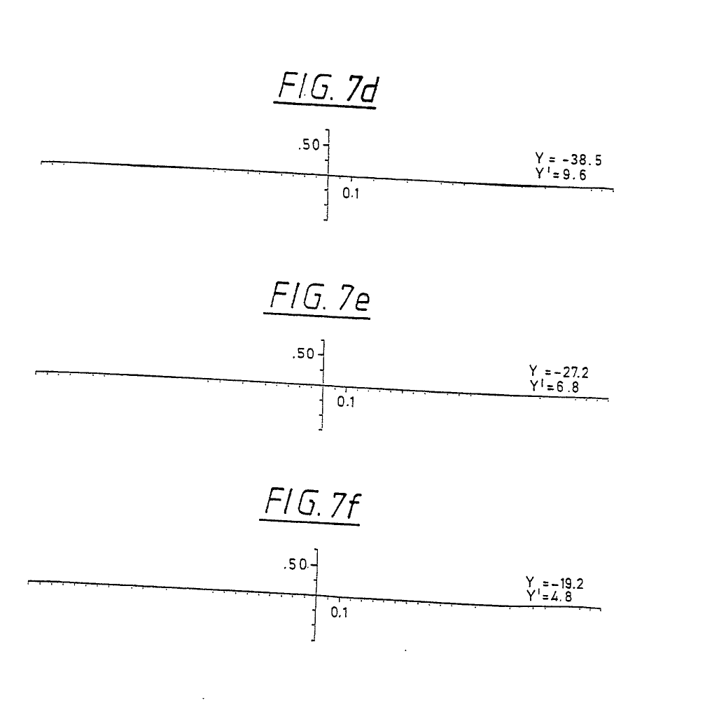

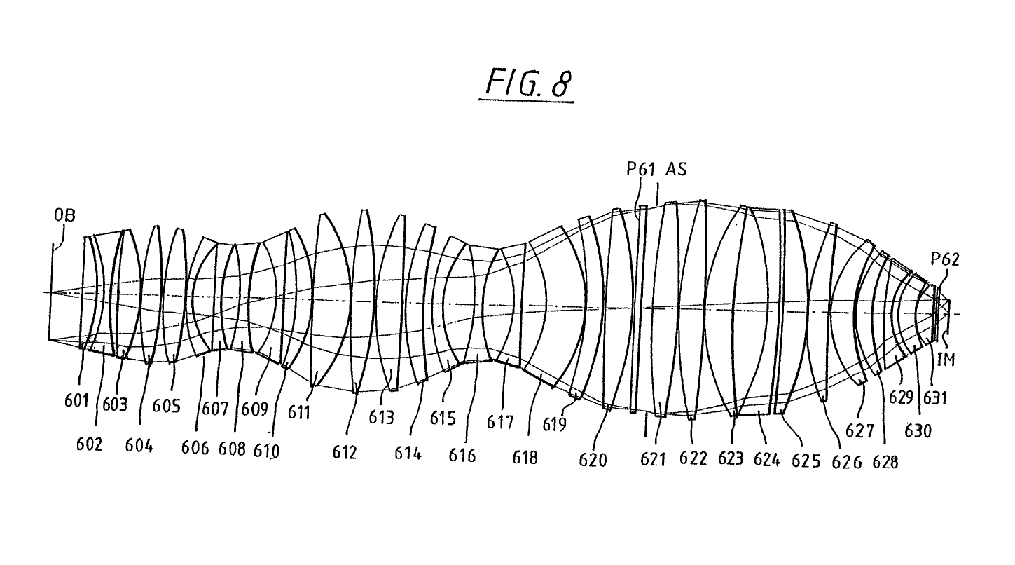

FIGS. 7a-7f give the groove error DYS for the same image heights; it is nearly zero throughout.

The exact lens data can be gathered from Table 3; the aspheric lens surfaces 27, 29, 31 have a considerable contribution to the high image quality which can be guaranteed.

The curvature of the pupil plane AP amounts to 14.6 mm at full aperture. The deviation from telecentricity on stopping down to NA=0.62 is 1.5 mrad, determined as in the preceding examples.

A further lens arrangement for the wavelength 248 nm is shown in FIG. 8 and Table 4.

This example is furthermore constructed purely spherically. It is particularly designed so that the distortion and the further imaging errors remain minimal with substantial stopping down, even with different kinds of illumination (different degree of coherence, annular aperture illumination, quadrupole illumination). The pupil plane is corrected to a curvature of 18.5 mm at full aperture.

Also it comes about here that the curved image of the pupil was substantially compensated by targeted correction of the astigmatism in the tangential section.

The air lens between the lenses 623, 624, the splitting of the negative meniscus into two lenses 624, 625, and the position of the pupil plane at AS markedly separated by two positive lenses from the second waist (617), contribute to its leveling.

In a high-aperture projection lens for microlithography, the diaphragm errors are accordingly systematically corrected, so that an only slightly curved pupil plane makes stopping down possible without a loss of quality.

As already mentioned, the embodiment examples are not limitative for the subject of the invention.

TABLE 1
λ = (193 nm)

| No. | r (mm) | d (mm) | Glass | Hₘₐₓ (mm) |
|---|---|---|---|---|
| 0 | ∞ | 15.691 | | 64 |
| 21 | −154.467 | 11.998 | SiO₂ | 64 |
| | 446.437 | 12.272 | | 73 |
| 22 | −723.377 | 25.894 | SiO₂ | 74 |
| | −222.214 | .824 | | 80 |
| 23 | 920.409 | 26.326 | SiO₂ | 89 |
| | −287.371 | .750 | | 90 |
| 24 | 499.378 | 30.073 | SiO₂ | 94 |
| | −358.998 | .751 | | 94 |
| 25 | 238.455 | 27.454 | SiO₂ | 90 |
| | −3670.974 | .750 | | 89 |
| 26 | 182.368 | 13.402 | SiO₂ | 81 |
| | 115.264 | 31.874 | | 72 |
| 27 | −710.373 | 13.095 | SiO₂ | 72 |
| | −317.933 | 2.550 | | 71 |
| 28 | −412.488 | 8.415 | SiO₂ | 69 |
| | 132.829 | 32.913 | | 65 |
| 29 | −184.651 | 11.023 | SiO₂ | 66 |
| | 2083.916 | 28.650 | | 71 |
| 30 | −120.436 | 10.736 | SiO₂ | 72 |
| | −629.160 | 16.486 | | 86 |
| 31 | −213.698 | 24.772 | SiO₂ | 89 |
| | −151.953 | .769 | | 95 |
| 32 | 11013.497 | 48.332 | SiO₂ | 115 |
| | −202.880 | .750 | | 118 |
| 33 | −1087.551 | 22.650 | SiO₂ | 122 |
| | −483.179 | .750 | | 124 |
| 34 | 1797.628 | 23.724 | SiO₂ | 125 |
| | −1285.887 | .751 | | 125 |
| 35 | 662.023 | 23.589 | SiO₂ | 124 |
| | 45816.292 | .750 | | 123 |
| 36 | 361.131 | 22.299 | SiO₂ | 119 |
| | 953.989 | .750 | | 117 |
| 37 | 156.499 | 49.720 | CaF₂ | 107 |
| | 2938.462 | .154 | | 103 |
| 38 | 377.619 | 8.428 | SiO₂ | 94 |
| | 123.293 | 40.098 | | 80 |
| 39 | −425.236 | 10.189 | SiO₂ | 78 |
| | 413.304 | 18.201 | | 74 |
| 40 | −302.456 | 6.943 | SiO₂ | 73 |
| | 190.182 | 46.542 | | 73 |
| 41 | −109.726 | 9.022 | SiO₂ | 73 |
| | −1968.186 | 5.547 | | 89 |
| 42 | −765.656 | 37.334 | CaF₂ | 90 |
| | −146.709 | .753 | | 94 |
| 43 | 925.552 | 49.401 | CaF₂ | 108 |
| | −193.743 | .847 | | 109 |
| 44 | 507.720 | 22.716 | CaF₂ | 105 |
| | −1447.552 | 21.609 | | 104 |
| 45 | −250.873 | 11.263 | SiO₂ | 104 |
| | 314.449 | 2.194 | | 105 |
| 46 | 316.810 | 28.459 | CaF₂ | 106 |
| | −1630.246 | 4.050 | | 106 |
| AS | Diaphragm | 15.000 | | 106 |
| 47 | 312.019 | 45.834 | CaF₂ | 108 |
| | −388.881 | 11.447 | | 108 |
| 48 | −242.068 | 14.119 | SiO₂ | 107 |
| | 312.165 | 4.687 | | 112 |
| 49 | 327.322 | 49.332 | SiO₂ | 114 |
| | −372.447 | 14.727 | | 115 |
| 50 | −234.201 | 26.250 | SiO₂ | 115 |
| | −226.616 | .850 | | 118 |
| 51 | 203.673 | 45.914 | SiO₂ | 113 |
| | −3565.135 | .751 | | 111 |
| 52 | 157.993 | 29.879 | SiO₂ | 94 |
| | 431.905 | 14.136 | | 90 |
| 53 | −1625.593 | 12.195 | SiO₂ | 88 |
| | 230.390 | .780 | | 76 |
| 54 | 124.286 | 66.404 | SiO₂ | 71 |
| | 538.229 | 1.809 | | 46 |
| 55 | 778.631 | 4.962 | CaF₂ | 45 |
| | 43.846 | 2.050 | | 34 |
| 56 | 43.315 | 23.688 | CaF₂ | 33 |
| | 1056.655 | 2.047 | | 29 |
| P2 | ∞ | 2.000 | CaF₂ | 27 |
| | ∞ | 12.000 | | 26 |
| IM | ∞ | | | 14 |

Image-side numerical aperture 0.75
Image field diameter 29 mm
Lenses 37 of which CaF₂ 5
Chromatic longitudinal error
CHL (500 pm) = 0.15 mm
Chromatic transverse error
CHV (500 pm) = −0.55 mm

TABLE 2
m736a

| Lens | Radius | Thickness | Glasses | 1/2 lens diameter |
|---|---|---|---|---|
| | infinity | 16.6148 | | 60.752 |
| L201 | −140.92104 | 7.0000 | SiO₂ | 61.267 |
| | −4944.48962 | 4.5190 | | 67.230 |
| L202 | −985.90856 | 16.4036 | SiO₂ | 68.409 |
| | −191.79393 | .7500 | | 70.127 |
| L203 | 18376.81346 | 16.5880 | SiO₂ | 73.993 |
| | −262.28779 | .7500 | | 74.959 |
| L204 | 417.82018 | 21.1310 | SiO₂ | 77.129 |
| | −356.76055 | .7500 | | 77.193 |
| L205 | 185.38468 | 23.3034 | SiO₂ | 74.782 |
| | −1198.61550 | A7500 | | 73.634 |
| L206 | 192.13950 | 11.8744 | SiO₂ | 68.213 |
| | 101.15610 | 27.6353 | | 61.022 |
| L207 | −404.17514 | 7.0000 | SiO₂ | 60.533 |
| | 129.70591 | 24.1893 | | 58.732 |
| L208 | −235.98146 | 7.0584 | SiO₂ | 59.144 |
| | −203.88450 | .7500 | | 60.201 |
| L209 | −241.72595 | 7.0000 | SiO₂ | 60.490 |
| | 196.25453 | 33.3115 | | 65.017 |
| L210 | −122.14995 | 7.0000 | SiO₂ | 66.412 |
| | −454.65265 | A 10.8840 | | 77.783 |
| L211 | −263.01247 | 22.6024 | SiO₂ | 81.685 |
| | −149.71102 | 1.6818 | | 86.708 |
| L212 | −23862.31899 | 43.2680 | SiO₂ | 104.023 |
| | −166.87798 | .7500 | | 106.012 |
| L213 | 340.37670 | 44.9408 | SiO₂ | 115.503 |
| | −355.50943 | .7500 | | 115.398 |
| L214 | 160.11879 | 41.8646 | SiO₂ | 102.982 |
| | 4450.50491 | .7500 | | 100.763 |
| L215 | 172.51429 | 14.8261 | SiO₂ | 85.869 |
| | 116.88490 | 35.9100 | | 74.187 |
| L216 | −395.46894 | 7.0000 | SiO₂ | 72.771 |
| | 178.01469 | 28.0010 | | 66.083 |
| L217 | −176.03301 | 7.0000 | SiO₂ | 65.613 |
| | 188.41213 | 36.7224 | | 66.293 |
| L218 | −112.43820 | 7.0059 | SiO₂ | 66.917 |
| | 683.42330 | 17.1440 | | 80.240 |
| L219 | −350.01763 | 19.1569 | SiO₂ | 82.329 |
| | −194.58551 | .7514 | | 87.159 |
| L220 | −8249.50149 | 35.3656 | SiO₂ | 99.995 |
| | −213.88820 | .7500 | | 103.494 |
| L221 | 657.56358 | 31.3375 | SiO₂ | 114.555 |
| | −428.74102 | .0000 | | 115.245 |
| | infinity | 2.8420 | | 116.016 |
| | diaphragm | .0000 | | 116.016 |
| L222 | 820.30582 | 27.7457 | SiO₂ | 118.196 |
| | −520.84842 | 18.4284 | | 118.605 |
| L223 | 330.19065 | 37.7586 | SiO₂ | 118.273 |
| | −672.92481 | 23.8692 | | 117.550 |
| L224 | −233.67936 | 10.0000 | SiO₂ | 116.625 |
| | −538.42627 | 10.4141 | | 117.109 |
| L225 | −340.26626 | 21.8583 | SiO₂ | 116.879 |
| | 436.70958 | .7500 | | 117.492 |
| L226 | 146.87143 | 34.5675 | SiO₂ | 100.303 |
| | −224.85666 | .7500 | | 97.643 |
| L227 | 135.52861 | 29.8244 | SiO₂ | 86.066 |
| | 284.57463 | 18.9234 | | 79.427 |
| L228 | −7197.04545 | 11.8089 | SiO₂ | 72.964 |
| | 268.01973 | .7500 | | 63.351 |
| L229 | 100.56453 | 27.8623 | SiO₂ | 56.628 |
| | 43.02551 | 2.0994 | | 36.612 |
| L230 | 42.30652 | 63.9541 | SiO₂ | 36.023 |
| | 262.65551 | 1.9528 | | 28.009 |
| | Infinity | 12.000 | | 27.482 |
| | Infinity | | | 13.602 |

Aspheric Constants
Coefficients of aspheric surface 29:
EX = −0.17337407 * 10³
C 1 = 0.15292522 * 10⁻⁷
C 2 = 0.18756271 * 10⁻¹¹
C 3 −0.40702561 * 10⁻¹⁶
C 4 = 0.26176919 * 10⁻¹⁹
C 5 = −0.36300252 * 10⁻²³
C 6 = 0.42405765 * 10⁻²⁷
Coefficients of aspheric surface 27:
EX = −0.36949981 * 10¹
C 1 = 0.20355563 * 10⁻⁷
C 2 = −0.22884234 * 10⁻¹¹
C 3 = −0.23852614 * 10⁻¹⁶
C 4 = −0.19091022 * 10⁻¹⁹
C 5 = 0.27737562 * 10⁻²³
C 6 = −0.29709625 * 10⁻²⁷

TABLE 3

| Lens | Radius | Thickness | Glasses | 1/2 lens diameter |
|---|---|---|---|---|
| | Infinity | 17.8520 | | 60.958 |
| L301 | −131.57692 | 7.0000 | SiO₂ | 61.490 |
| | −195.66940 | .7500 | | 64.933 |
| L302 | −254.66366 | 8.4334 | SiO₂ | 65.844 |
| | −201.64480 | .7500 | | 67.386 |
| L303 | −775.65764 | 14.0058 | SiO₂ | 69.629 |
| | −220.44596 | .7500 | | 70.678 |
| L304 | 569.58638 | 18.8956 | SiO₂ | 72.689 |
| | −308.25184 | .7500 | | 72.876 |
| L305 | 202.68033 | 20.7802 | SiO₂ | 71.232 |
| | −1120.20883 | A7500 | | 70.282 |
| L306 | 203.03395 | 12.1137 | SiO₂ | 65.974 |
| | 102.61512 | 26.3989 | | 59.566 |
| L307 | −372.05336 | 7.0000 | SiO₂ | 59.203 |
| | 144.40889 | 23.3866 | | 58.326 |
| L308 | −207.93626 | 7.0303 | SiO₂ | 58.790 |
| | −184.65938 | .7500 | | 59.985 |
| L309 | −201.97720 | 7.0000 | SiO₂ | 60.229 |
| | 214.57715 | 33.1495 | | 65.721 |
| L310 | −121.80702 | 7.0411 | SiO₂ | 67.235 |
| | −398.26353 | A 9.7571 | | 79.043 |
| L311 | −242.40314 | 22.4966 | SiO₂ | 81.995 |
| | −146.76339 | .7553 | | 87.352 |
| L312 | −2729.19964 | 45.3237 | SiO₂ | 104.995 |
| | −158.37001 | .7762 | | 107.211 |
| L313 | 356.37642 | 52.1448 | SiO₂ | 118.570 |
| | −341.95165 | 1.1921 | | 118.519 |
| L314 | 159.83842 | 44.6278 | SiO₂ | 105.627 |
| | 234.73586 | .7698 | | 102.722 |
| L315 | 172.14697 | 16.8960 | SiO₂ | 88.037 |
| | 119.53455 | 36.6804 | | 75.665 |
| L316 | −392.62196 | 7.0000 | SiO₂ | 74.246 |
| | 171.18767 | 29.4986 | | 67.272 |
| L317 | −176.75022 | 7.0000 | SiO₂ | 66.843 |
| | 186.50720 | 38.4360 | | 67.938 |
| L318 | −113.94008 | 7.0213 | SiO₂ | 68.650 |
| | 893.30270 | 17.7406 | | 82.870 |
| L319 | −327.77804 | 18.9809 | SiO₂ | 85.090 |
| | −192.72640 | .7513 | | 89.918 |
| L320 | −3571.89972 | 34.3608 | SiO₂ | 103.882 |
| | −209.35555 | .7500 | | 106.573 |
| L321 | 676.38083 | 62.6220 | SiO₂ | 119.191 |
| | −449.16650 | .0000 | | 119.960 |
| | Infinity | 2.8420 | | 120.991 |
| | Diaphragm | .0000 | | 120.991 |
| L322 | 771.53843 | 30.6490 | SiO₂ | 123.568 |
| | −525.59771 | 13.4504 | | 124.005 |
| L323 | 330.53202 | 40.0766 | SiO₂ | 123.477 |
| | −712.47666 | 23.6787 | | 122.707 |
| L324 | −250.00950 | 10.0000 | SiO₂ | 121.877 |
| | −513.10270 | 14.8392 | | 121.995 |
| L325 | −344.63359 | 20.3738 | SiO₂ | 121.081 |
| | −239.53067 | .7500 | | 121.530 |
| L326 | 146.13385 | 34.7977 | SiO₂ | 102.544 |
| | 399.32557 | .7510 | | 99.992 |
| L327 | 132.97289 | 29.7786 | SiO₂ | 87.699 |
| | 294.53397 | 18.8859 | | 82.024 |
| L328 | −3521.27938 | A 11.4951 | SiO₂ | 75.848 |
| | 287.11066 | .7814 | | 65.798 |
| L329 | 103.24804 | 27.8602 | SiO₂ | 58.287 |
| | 41.64286 | 1.9089 | | 36.734 |
| L330 | 41.28081 | 31.0202 | SiO₂ | 36.281 |
| | 279.03201 | 1.9528 | | 28.934 |
| | infinity | 12.0000 | | 28.382 |
| | infinity | | | 13.603 |

Aspheric Constants
Coefficients of aspheric surface 29:
EX = −0.16784093 * 10³
C 1 = 0.49600479 * 10⁻⁹
C 2 = 0.31354487 * 10⁻¹¹
C 3 = −0.65827200 * 10⁻¹⁶
C 4 = 0.44673095 * 10⁻¹⁹
C 5 = −0.73057048 * 10⁻²³
C 6 = 0.91524489 * 10⁻²⁷
Coefficients of aspheric surface 27:
EX = −0.22247325 * 10¹
C 1 = 0.24479896 * 10⁻⁷
C 2 = −0.22713172* 10⁻¹¹
C 3 = 0.36324126 * 10⁻¹⁶
C 4 = −0.17823969 * 10⁻¹⁹
C 5 = 0.26799048 * 10⁻²³
C 6 = −0.27403392 * 10⁻²⁷
Coefficients of aspheric surface 31:
EX = 0
C 1 = −0.45136584 * 10⁻⁰⁹
C 2 = 0.34745936 * 10⁻¹²
C 3 = 0.11805250 * 10⁻¹⁷
C 4 = −0.87762405 * 10⁻²¹

TABLE 4

| No. | r (mm) | d (mm) | Glass |
|---|---|---|---|
| 0b | | 36.005 | |
| 601 | −1823.618 | 15.518 | Quartz Glass |
| | −214.169 | 10.000 | |
| 602 | −134.291 | 7.959 | Quartz Glass |
| | 328.009 | 6.376 | |
| 603 | 783.388 | 26.523 | Quartz Glass |
| | −163.805 | .600 | |
| 604 | 325.109 | 20.797 | Quartz Glass |
| | −499.168 | 1.554 | |
| 605 | 224.560 | 24.840 | Quartz Glass |
| | −403.777 | .600 | |
| 606 | 142.336 | 9.000 | Quartz Glass |
| | 86.765 | 23.991 | |
| 607 | 6387.721 | 7.700 | Quartz Glass |
| | 148.713 | 21.860 | |
| 608 | −185.678 | 8.702 | Quartz Glass |
| | 237.204 | 30.008 | |
| 609 | −104.297 | 9.327 | Quartz Glass |
| | −1975.424 | 12.221 | |
| 610 | −247.819 | 17.715 | Quartz Glass |
| | −152.409 | .605 | |
| 611 | 1278.476 | 40.457 | Quartz Glass |
| | −163.350 | .778 | |
| 612 | 697.475 | 28.012 | Quartz Glass |
| | −346.153 | 2.152 | |
| 613 | 232.015 | 28.068 | Quartz Glass |
| | −3080.194 | 2.606 | |
| 614 | 219.153 | 21.134 | Quartz Glass |
| | 434.184 | 9.007 | |
| 615 | 155.091 | 13.742 | Quartz Glass |
| | 103.553 | 34.406 | |
| 616 | −207.801 | 8.900 | Quartz Glass |
| | 131.833 | 35.789 | |
| 617 | −118.245 | 9.299 | Quartz Glass |
| | 1262.191 | 27.280 | |
| 618 | −121.674 | 42.860 | Quartz Glass |
| | −151.749 | .825 | |
| 619 | −366.282 | 20.128 | Quartz Glass |
| | −236.249 | .838 | |
| 620 | 2355.228 | 31.331 | Quartz Glass |
| | −296.219 | 2.500 | |
| P61 | ∞ | 6.000 | Quartz Glass |
| | ∞ | 12.554 | |
| AS | | | |
| 621 | 774.283 | 29.041 | Quartz Glass |
| | −782.899 | .671 | |
| 622 | 456.969 | 28.257 | Quartz Glass |
| | −1483.609 | .603 | |
| 623 | 227.145 | 30.951 | Quartz Glass |
| | 658.547 | 36.122 | |
| 624 | −271.535 | 15.659 | Quartz Glass |
| | −997.381 | 4.388 | |
| 625 | −1479.857 | 27.590 | Quartz Glass |
| | −288.684 | .604 | |
| 626 | 259.988 | 22.958 | Quartz Glass |
| | 1614.379 | .600 | |
| 627 | 105.026 | 29.360 | Quartz Glass |
| | 205.658 | .600 | |
| 628 | 110.916 | 16.573 | Quartz Glass |
| | 139.712 | 13.012 | |
| 629 | 499.538 | 8.300 | Quartz Glass |
| | 56.675 | 9.260 | |
| 630 | 75.908 | 17.815 | Quartz Glass |
| | 51.831 | .995 | |
| 631 | 43.727 | 19.096 | Quartz Glass |
| | 499.293 | 2.954 | |
| P62 | ∞ | 2.000 | Quartz Glass |
| | ∞ | 12.000 | |
| Im | | | |

What is claimed is:

1. A microlithographic projection lens having a system diaphragm arranged in a region of a last bulge on an image side, and having an image-side numerical aperture of more than 0.65 and an image field diameter of more than 20 mm, wherein a pupil plane is curved over a cross section of a pencil of rays by a maximum of 20 mm.

2. A microlithographic projection lens according to claim 1, wherein said pupil plane is curved by a maximum of less than 15 mm.

3. A microlithographic projection lens having a system diaphragm arranged in a region of a last bulge on an image side, and having an image-side numerical aperture of more than 0.65 and an image field diameter of more than 20 mm, wherein the lens has a telecentricity deviation of less than ±4 mrad of a geometric central beam, on stopping down to 0.8 times said image-side numerical aperture.

4. A microlithographic projection lens according to claim 3, wherein said telecentricity deviation is less than ±3 mrad.

5. A microlithographic projection lens having a system diaphragm arranged in a region of a last bulge on an image side, and having an image-side numerical aperture of more than 0.65 and an image field diameter of more than 20 mm, wherein a tangential image dishing of a pupil image in a diaphragm space is corrected to less than 20 mm.

6. The microlithographic projection lens according to claim 5, wherein the tangential image dishing of the pupil image in the diaphragm space is corrected to less than 15 mm.

7. A projection lens according to claim 1, wherein a first negative lens that follows the pupil plane in a beam path is a meniscus that is concave on a pupil side.

8. A projection lens according to claim 1, wherein a lens group of negative refractive power is arranged at each waist, and a lens group of positive refractive power is arranged at each bulge, and wherein at least two positive lenses of a lens group of a third bulge are arranged before the pupil plane.

9. The projection lens according to claim 8, wherein at least three of the positive lenses are arranged before the pupil plane.

10. The projection lens according to claim 1, wherein at least one spherically overcorrecting air space is arranged between adjacent lenses in a region of a third bulge before the pupil plane.

11. The projection lens according to claim 1, wherein a lens with an aspheric surface is arranged before a first waist.

12. The projection lens according to claim 1, wherein a second waist comprises only spherical lenses.

13. The projection lens according to claim 1, wherein quartz glass and fluoride crystals, individually or in combination, are used as lens material.

14. The projection lens according to claim 13, wherein the crystals comprise particularly CaF₂, BaF₂, SrF₂, LiF.

15. The projection lens according to claim 1, comprising two waists and three bulges.

16. A microlithographic projection exposure device comprising a projection lens according to claim 1.

17. A process for producing microstructured components, comprising the steps of:
exposing a substrate provided with a photosensitive layer with ultraviolet light via a mask and a projection exposure device according to claim 11, and if necessary, after development of the photosensitive layer, the substrate is structured corresponding to a pattern contained on the mask.

18. The process according to claim 16, comprising several exposures with at least one of different kinds of illumination and numerical apertures.
